(19) United States
(12) Patent Application Publication
(10) Pub. No.: US 2026/0346407 A1
(43) Pub. Date: Nov. 5, 2026

(54) ADJUSTABLE WRENCH

(71) Applicant: PROXENE TOOLS CO., LTD., Taichung City (TW)

(72) Inventors: Chang-Ming WU, Taichung City (TW); Arthur WU, Taichung City (TW)

(21) Appl. No.: 19/194,717

(22) Filed: Apr. 30, 2025

(51) Int. Cl. B25B 13/14

(52) U.S. Cl. CPC B25B 13/14

(57) ABSTRACT

An adjustable wrench is provided, wherein the adjustable wrench includes: a main body including a handle and a working head connected to the handle, the working head including a side surface, an end surface transversely connected to the side surface, a fixed jaw protruding beyond the end surface, a slot, and an worm shaft rotatably disposed within the slot, the side surface including first and second transitional portions located at opposing sides of the slot, the first and second transitional portions extending outward relative to the slot, a direction in which the end surface extends being defined as a reference line, a first distance from the first transitional portion to the reference line being different from a second distance from the second transitional portion to the reference line; and a movable jaw movably mounted on the working head and engaging with the worm shaft.

### BACKGROUND OF THE INVENTION

### Field of the Invention

The present invention relates to a driving tool, particularly to an adjustable wrench.

### Description of the Prior Art

Adjustable wrench has an adjustable opening size and is applicable to fastening elements of various sizes. Therefore, it is commonly used in the fields of assembly, joining, and fastening of devices. A general adjustable wrench includes a fixed jaw, a movable jaw that is movably adjusted relative to the fixed jaw, and a worm shaft engaged with a toothed row of the movable jaw. By rotating the worm shaft, the movable jaw can be driven to move toward or away from the fixed jaw, thereby adjusting the opening size of the adjustable wrench.

However, in conventional adjustable wrenches, the slot accommodating the worm shaft typically has sharp edges at the opening and does not conform to the shape of a finger, making operation uncomfortable and prone to hand injury. Furthermore, there is no structural design on either side of the slot that facilitates finger access into the slot, resulting in jamming and difficulty in applying force during operation.

The present invention is, therefore, arisen to obviate or at least mitigate the above-mentioned disadvantages.

### SUMMARY OF THE INVENTION

The main object of the present invention is to provide an adjustable wrench capable of improving comfort, stability, and smoothness of operation.

To achieve the above and other objects, an adjustable wrench is provided, wherein the adjustable wrench includes: a main body including a handle and a working head connected to the handle, the working head including a side surface, an end surface transversely connected to the side surface, a fixed jaw extending and protruding beyond the end surface, a slot, and an worm shaft rotatably disposed within the slot, the side surface including a first transitional portion and a second transitional portion located at opposing sides of the slot, the first transitional portion and the second transitional portion extending outward relative to the slot, a direction in which the end surface extends being defined as a reference line, a first distance from the first transitional portion to the reference line being different from a second distance from the second transitional portion to the reference line; and a movable jaw movably mounted on the working head and engaging with the worm shaft.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is a front view of an exemplary embodiment of the present invention;

FIG. 3 is a partial enlarged view of an exemplary embodiment of the present invention;

FIG. 4 is a cross-sectional view of an exemplary embodiment of the present invention;

FIG. 5 is a partial enlarged view of FIG. 4;

FIG. 6 is another cross-sectional view of an exemplary embodiment of the present invention; and

FIG. 7 is a front view of another exemplary embodiment of the present invention.

### DETAILED DESCRIPTION OF THE PREFERRED EMBODIMENTS

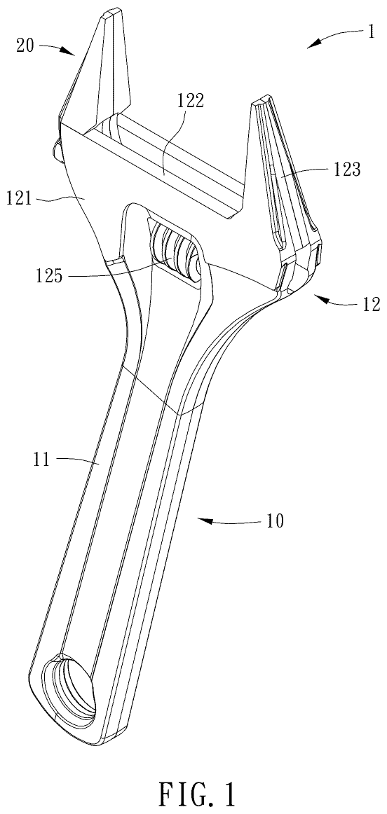

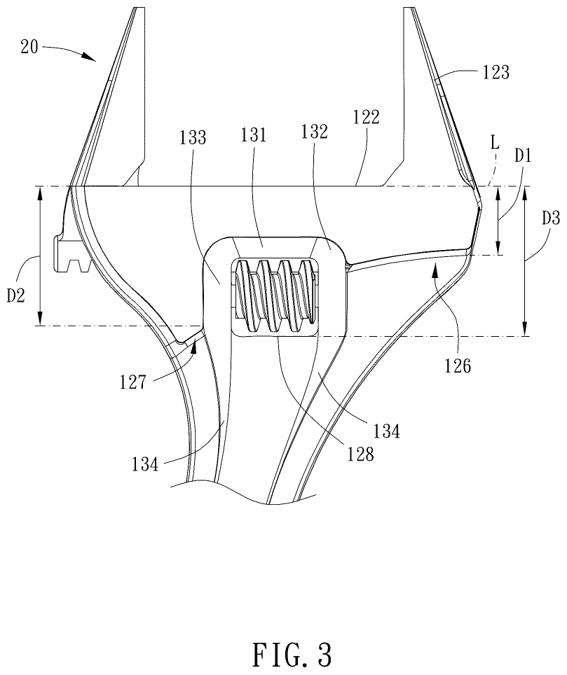

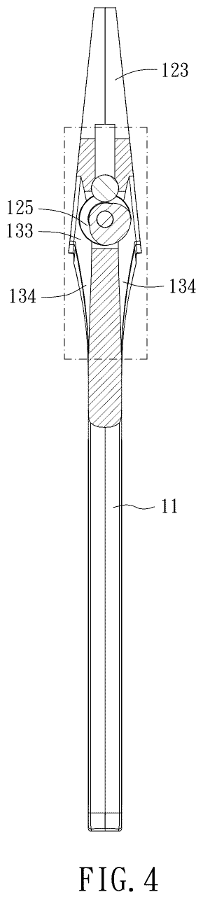

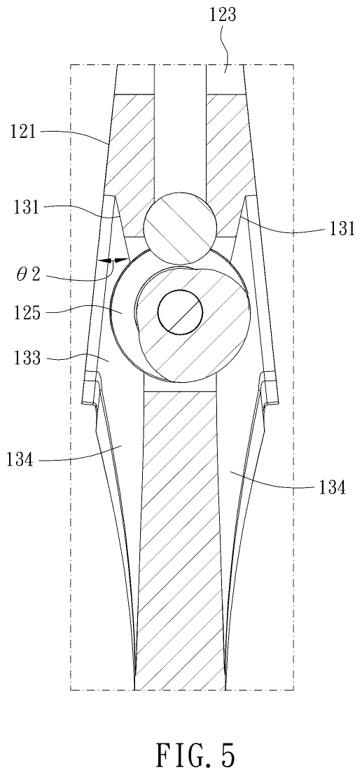

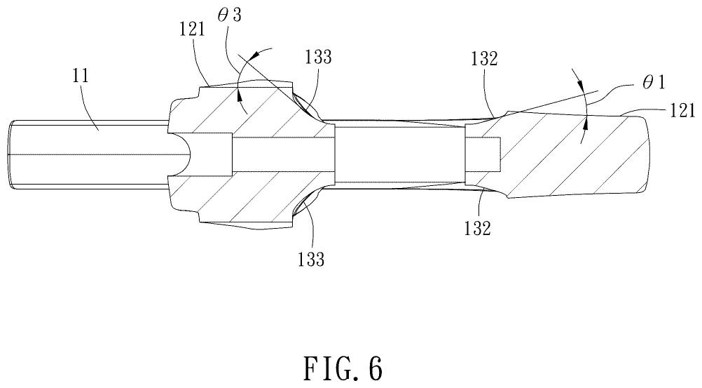

Please refer to FIGS. 1 to 6 for an exemplary embodiment of the present invention. An adjustable wrench 1 of the present invention includes a main body 10 and a movable jaw 20.

The main body 10 includes a handle 11 and a working head 12 connected to the handle 11. The working head 12 includes a side surface 121, an end surface 122 transversely connected to the side surface 121, a fixed jaw 123 protruding from the end surface 122, a slot 124, and a worm shaft 125 rotatably mounted in the slot 124. The side surface 121 includes a first transitional portion 126 and a second transitional portion 127 respectively located on opposing sides of the slot 124. The first transitional portion 126 and the second transitional portion 127 extend outward relative to the slot 124. A reference line L is defined in a direction in which the end surface 122 extends. A first distance D1 from the first transitional portion 126 to the reference line L is different from a second distance D2 from the second transitional portion 127 to the reference line L. The movable jaw 20 is movably mounted on the working head 12 and engaged with the worm shaft 125. As such, operational comfort, stability, and smoothness are improved.

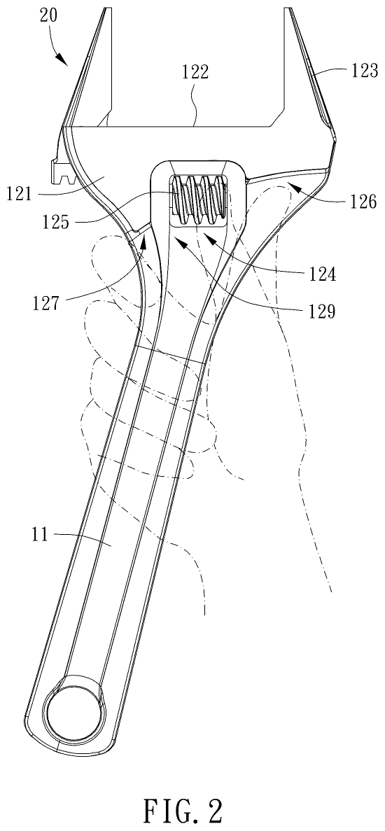

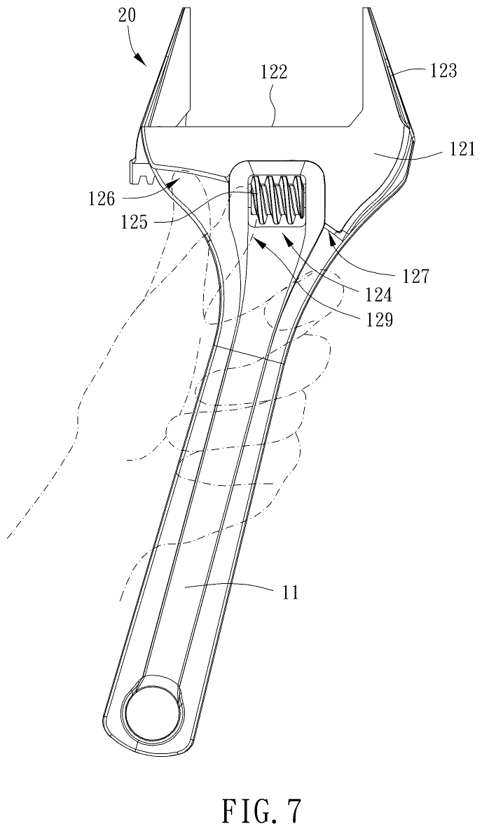

The first transitional portion 126 and the second transitional portion 127 may be stepped structures, planar transitional structures, or chamfered structures. In this embodiment, they are stepped structures. A portion of the working head 12 located on a side by the first transitional portion 126 and the second transitional portion 127 and farther from the reference line L has a thickness smaller than a thickness of a portion located of the working head 12 located on a side by the first transitional portion 126 and the second transitional portion 127 and located closer to the reference line L, such that the thinner portion facilitates finger access into the slot 124, and the thicker portion provides finger support and alignment. For right-handed users, the first transitional portion 126 and the fixed jaw 123 are located on the same side of the working head 12, and the first distance D1 is less than a third distance D3 from a bottom edge 128 of the slot 124 to the reference line L, thereby making the structural profile more ergonomic for finger insertion and worm shaft 125 operation. In this embodiment, the second distance D2 is less than the third distance D3; however, in other embodiments, the second distance may be greater than the third distance. The first transitional portion 126 extends gradually farther away from the reference line L in a direction from an outer end of the working head 12 toward the slot 124, and the second transitional portion 127 extends gradually closer to the reference line L in a direction from another outer end of the working head 12 toward the slot 124, allowing unrestricted finger motion. In other embodiments, for left-handed users, the positions of the first transitional portion 126 and the second transitional portion 127 may be interchanged in location (as shown in FIG. 7). With this design, excellent guidance is achieved whether operated by the right or left thumb (see FIGS. 2 and 7), enabling natural movement in a preferred direction without interference.

The slot 124 includes a circumferential surface 129 which expands toward the side surface 121, enabling the user's finger to enter the slot 124 more smoothly. Specifically, the circumferential surface 129 includes an upper inclined surface 131, and a first side inclined surface 132, and a second side inclined surface 133. Widths of the first side inclined surface 132 and the second side inclined surface 133 are greater than a width of the upper inclined surface 131, providing a contact surface more conforming to the finger shape. The inclined surfaces 131, 132, and 133 may be planar or curved. Relative to the side surface 121 of the working head 12, a first inclination angle θ1 of the first side inclined surface 132 is less than a second inclination angle θ2 of the upper inclined surface 131. A third inclination angle θ3 of the second side inclined surface 133 may be either less than or greater than the second inclination angle θ2. With this design, the upper inclined surface 131 provides proper finger stop without overshooting the slot 124, the first side inclined surface 132 facilitates smooth finger access into the slot 124, and the second side inclined surface 133 enhances comfort and stability during operation. The first inclination angle θ1 is preferably not greater than 40 degrees, and the second inclination angle θ2 is preferably not less than 45 degrees. For example, the first inclination angle θ1 may be 15 degrees, 20 degrees, 25 degrees, 30 degrees, 35 degrees, 40 degrees, or any angle between these values; the second inclination angle θ2 may be 50 degrees, 55 degrees, 60 degrees, 65 degrees, 70 degrees, 75 degrees, 80 degrees, 85 degrees, or any angle between these values; the third inclination angle θ3 may be 50 degrees, 55 degrees, 60 degrees, 65 degrees, 70 degrees, 75 degrees, 80 degrees, 85 degrees, or any angle between these values.

Preferably, the circumferential surface 129 further includes two tapered inclined surfaces 134 tapering respectively from the first side inclined surface 132 and the second side inclined surface 133 toward the handle 11, making the overall finger fit more ergonomic and helping improve comfort, stability, and smoothness during operation.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An adjustable wrench including:
a main body including a handle and a working head connected to the handle, the working head including a side surface, an end surface transversely connected to the side surface, a fixed jaw extending and protruding beyond the end surface, a slot, and an worm shaft rotatably disposed within the slot, the side surface including a first transitional portion and a second transitional portion located at opposing sides of the slot, the first transitional portion and the second transitional portion extending outward relative to the slot, a direction in which the end surface extends being defined as a reference line, a first distance from the first transitional portion to the reference line being different from a second distance from the second transitional portion to the reference line; and
a movable jaw movably mounted on the working head and engaging with the worm shaft.

2. The adjustable wrench of claim 1, wherein the first transitional portion and the fixed jaw are located on a same side of the working head, and the first distance is less than a third distance from a bottom edge of the slot to the reference line.

3. The adjustable wrench of claim 2, wherein the second distance is less than the third distance.

4. The adjustable wrench of claim 1, wherein the slot includes a circumferential surface, and the circumferential surface expands toward the direction of the side surface.

5. The adjustable wrench of claim 4, wherein the circumferential surface includes an upper inclined surface, a first side inclined surface and a second side inclined surface, and widths of the first side inclined surface and the second side inclined surface are greater than a width of the upper inclined surface.

6. The adjustable wrench of claim 5, wherein relative to the side surface of the working head, a first inclination angle of the first side inclined surface is less than a second inclination angle of the upper inclined surface.

7. The adjustable wrench of claim 6, wherein the circumferential surface further includes two tapered inclined surfaces respectively tapering from the first side inclined surface and the second side inclined surface toward the direction of the handle.

8. The adjustable wrench of claim 1, wherein a portion of the working head located on a side by the first transitional portion and the second transitional portion and located farther from the reference line has a thickness less than a thickness of a portion of the working head located on a side by the first transitional portion and the second transitional portion and located closer to the reference line.

9. The adjustable wrench of claim 7, wherein the first transitional portion and the fixed jaw are located on a same side of the working head; the first distance is less than the third distance from the bottom edge of the slot to the reference line; the first inclination angle is not greater than 40 degrees; the second inclination angle is not less than 45 degrees; the first transitional portion and the second transitional portion are stepped structures, planar transitional structures or chamfered structures; a portion of the working head located on a side by the first transitional portion and the second transitional portion and located farther from the reference line has a thickness less than a thickness of a portion of the working head located on a side by the first transitional portion and the second transitional portion and located closer to the reference line.

10. The adjustable wrench of claim 1, wherein the first transitional portion extends gradually farther away from the reference line in a direction from an outer end of the working head toward the slot, and the second transitional portion extends gradually closer to the reference line in a direction from another outer end of the working head toward the slot.
